(19) United States
(12) Patent Application Publication
(10) Pub. No.: US 2016/0342921 A1
(43) Pub. Date: Nov. 24, 2016

(54) EMPLOYEE CYCLIC AWARD TRACKING SYSTEM

(71) Applicants: Matthew P. Morin, Detroit, MI (US); Kevin J. Morin, Detroit, MI (US)

(72) Inventors: Matthew P. Morin, Detroit, MI (US); Kevin J. Morin, Detroit, MI (US)

(21) Appl. No.: 15/159,239

(22) Filed: May 19, 2016

Related U.S. Application Data
(60) Provisional application No. 62/163,457, filed on May 19, 2015.

(51) Int. Cl. G06Q 10/06; G06F 17/30

(52) U.S. Cl. CPC G06Q 10/06393; G06Q 10/06398; G06F 17/3053

(57) ABSTRACT

The present invention is directed to an employee task docketing and cyclic award tracking system method. The method includes providing a network, a computer server, a database on the computer server and one or more workstations for storing one or more past periodic award files for a plurality of users. The computer server is connected to the network and is capable of receiving one or more inputs from one or more workstations connected to the network. The network can be either a local area network or may be a cloud-based network accessible through the Internet.

### CROSS-REFERENCE TO RELATED APPLICATIONS

This application claims the benefit of U.S. Provisional Application No. 62/163,457, filed May 19, 2015. The disclosure of the above application is incorporated herein by reference.

### FIELD OF THE INVENTION

The present invention relates to an add-on employee objective cyclic award tracking system designed to docket and organize tasks, motivate employees and automatically grant monetary and recognition awards based on employee or user performance.

### BACKGROUND OF THE INVENTION

In businesses and other organizations it is necessary to manage employee performance in order to maximize the employees' contribution to the organization to help the organization achieve its strategic goals. One management approach used is to try to motivate and inspire employees to meet their individual and team goals. It is difficult to establish a system that consistently inspires and motivates employees because often organizations are not consistent or able to recognize employee achievement in a timely manner that will inspire and motivate the employees.

There are various approaches that attempt to address performance management and provide compensation to employees in the marketplace. Common approaches involve performance reviews, merit increases, incentive plans, and recognition programs that attempt to solve the performance management and reward issues within organizations. Some of these approaches include running reports to determine performance well after the fact, at the end of a reporting period. All of these approaches force managers and supervisors to review data from many sources and to try to subjectively determine employee performance by their subjective standards. Also such reviews are sometimes not performed consistently because of the amount of time it takes to perform them, which in turn does not inspire and motivate the employees effectively due to time between reviews and consistency of management. It is desirable to recognize employee achievement in an active and consistent manner that will in turn inspire and motivate the employee.

### SUMMARY OF THE INVENTION

A computer based system for calculating escalating incentive payments for individuals or groups based on tracking repeated compliance with desired actions. The system can be used over any assessment period also referred to as cycles and any number of repeated observations also referred to as time periods (e.g. measured daily over a month, measured daily or monthly over a year, measured yearly over 10 years) and provides escalating periodic incentive payments until there is a failure to comply with the desired actions or until a designated reset point is reached and the cycle completes (e.g., a monthly compliance streak or a preset dollar cap), at which point the available incentive payments reset to predetermined base level. The system accepts entry of any start term (e.g., a base dollar amount) and any growth rate.

The present invention is directed to an employee task docketing and cyclic award tracking system that motivates employees to input data concerning the completion of specific tasks into a computer program or network using a primary program. The specific tasks can be any type of task. For example in a service industry setting the task can be inputting billable hours, rectifying outstanding customer service issues, while in other settings, such as a manufacturing setting the tasks can be related to a particular employee's product output or unit output. The inputted data concerning specific tasks is then tracked over a large block of time, such as a week, month or year and is referred to as a cycle. The cycle is any specific period of time however generally speaking the tasks are such that they require completion on regular scheduled repetitive periods.

The system or method is designed to transform the completion of tasks and desired employee behavior into an objectively calculated award based on employees meeting certain performance or behavior goals. The completion of tasks are ultimately transformed into recognition awards and monetary awards that are based upon an automated system, that takes the employee or user inputted tasks, and calculates a ranking award and a monetary award. The awards, both ranking awards and monetary awards are continuously updated over a given period of time in order to gamify and motivate the employees to compete with their peers and also receive individual achievement awards.

The employee task docketing and cyclic award tracking system is provided on a server operating an add-on software program that is associated with a primary program that the employee uses to input information concerning a specific task. The add-on software program determines whether or not the employee has been compliant, based on the employee inputting task information into the primary program. For example the primary program can be time tracking software used by service industry employees. The primary program can also be another type of docketing program that requires employees to input information about whether or not tasks have been performed.

The employee task docketing and cyclic award tracking system will detect when an employee has completed tasks, typically by primary program sending an instruction to the add-on software program that the employee has been compliant or noncompliant. Once it is been determined that the employee has been compliant or noncompliant a data entry on the add-on software program is recorded. The recording of data occurs over a specific period of time, which can be one week, one month, one year or whatever specific period of time is necessary.

The present invention is directed to an employee task docketing and cyclic award tracking system method. The method includes providing a network, a computer server, a database on the computer server and one or more workstations for storing one or more past periodic award files for a plurality of users. The computer server is connected to the network and is capable of receiving one or more inputs from one or more workstations connected to the network. The network can be either a local area network or may be a cloud-based network accessible through the Internet.

The method further includes providing a primary program, such as a task management software program operating on the server or the one or more workstations for recording specific tasks based on one or more inputs from the workstations. The method further includes providing a secondary program that is an ad-on employee task docketing and cyclic award tracking program capable of interacting with the primary program. The secondary program interacts with the primary program and automates the tracking and awarding of a specific behavior for a plurality of users. The secondary program is coded directly into the primary program or the secondary program is accessed through an Internet protocol of the primary program, wherein the primary program communicates with the secondary program through the Internet.

Next the method includes the step of activating one of two or more predetermined time periods of a first cycle of the secondary program and monitoring the primary program with the secondary program for the one of the two or more predetermined time periods. Next one of the plurality of users uses the one or more workstations to create an input to the primary program. Then the method includes relaying the input from the primary program to the secondary program and then using the secondary program to determine whether the input is accepted by rules programmed into the secondary program. If the input is not accepted the secondary program assigns a zero value current periodic award when the input is not accepted. Next the method includes assigning a current periodic award to one of the plurality of users if an accepted input has been determined.

During the step of assigning the current periodic award the secondary program has a base value amount and one or more multiplier calculations programmed on the secondary program. The next step includes determining whether the input is for the first one of the two or more time periods of the first cycle and assigning the current periodic award a value of the base value amount when the input is for the first one of two or more time periods of the first cycle. If the input is not for the first one of the two or more time periods of the first cycle then during the next step the secondary program begins checking the database to determine if the one of the plurality of users have any one or more past periodic award files for an immediately preceding time period. Then the step of calculating the current periodic award occurs. The calculation is performed using one of the one or more multiplier calculations and multiplying by the one or more past periodic award files for the immediately preceding time period if found or assigning the current periodic award a value of the base value amount when there are no one or more past periodic award files for the immediately preceding time period.

Next the current periodic award is recorded in the database as a past periodic award file and then an automatic award notification is send to the one of the plurality of users to which the award notification pertains. Then the secondary program begins a second one of the two or more time periods of the first cycle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an overall schematic view of the employee task docketing and cyclic award tracking system;

FIG. 2 is a flow chart diagram showing the overall process of the cyclic award tracking system in accordance with the present invention;

FIG. 3 is a screenshot of an activity wall with rankings of cumulative points awarded in accordance with the present invention; and

FIG. 4 is a screenshot of all the users of the organization;

FIG. 5 shows is a table showing the results of the invention in use; and

FIG. 6 is a screenshot of an exemplary data input screen of the primary software program.

### DETAILED DESCRIPTION OF THE PREFERRED EMBODIMENTS

The following description of the preferred embodiment(s) is merely exemplary in nature and is in no way intended to limit the invention, its application, or uses.

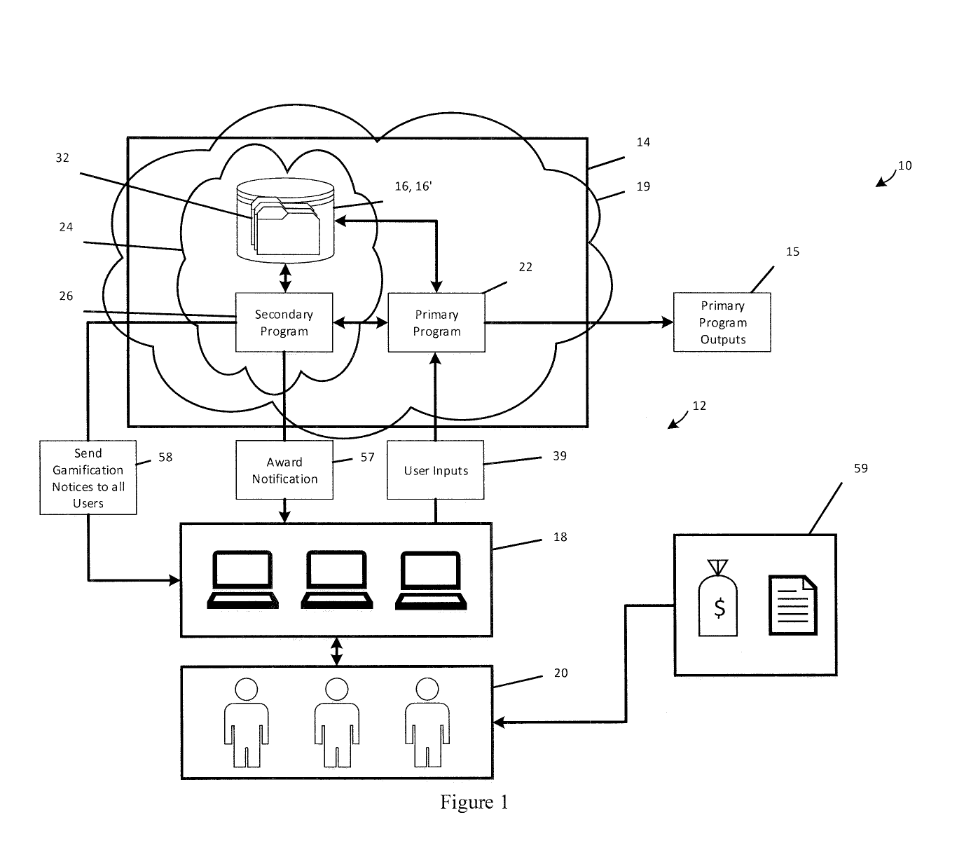

Referring now to FIG. 1 a schematic diagram showing an overview of the employee task docketing and cyclic award tracking program system and portions of the method 10 are shown. The method 10 includes providing a network 12 having a computer server 14, a database 16 and one or more workstations 18 to which one or more users 20 create an input by inputting data into a primary program 22 residing on the computer server 14. The workstations 18 are desktop or laptop computers, however, it is within the scope of this invention for the workstations to be smartphones, tablets or other mobile devices. The terms “user” and “users” as used herein include employee, employees, team, teams, organizations, contact employees, contractors, workers, etc. The terms “final award”, “past periodic award files” and “current periodic award” can be any numerical value, such as but not limited to points, money values, etc. used in determining rankings and intangible awards described herein.

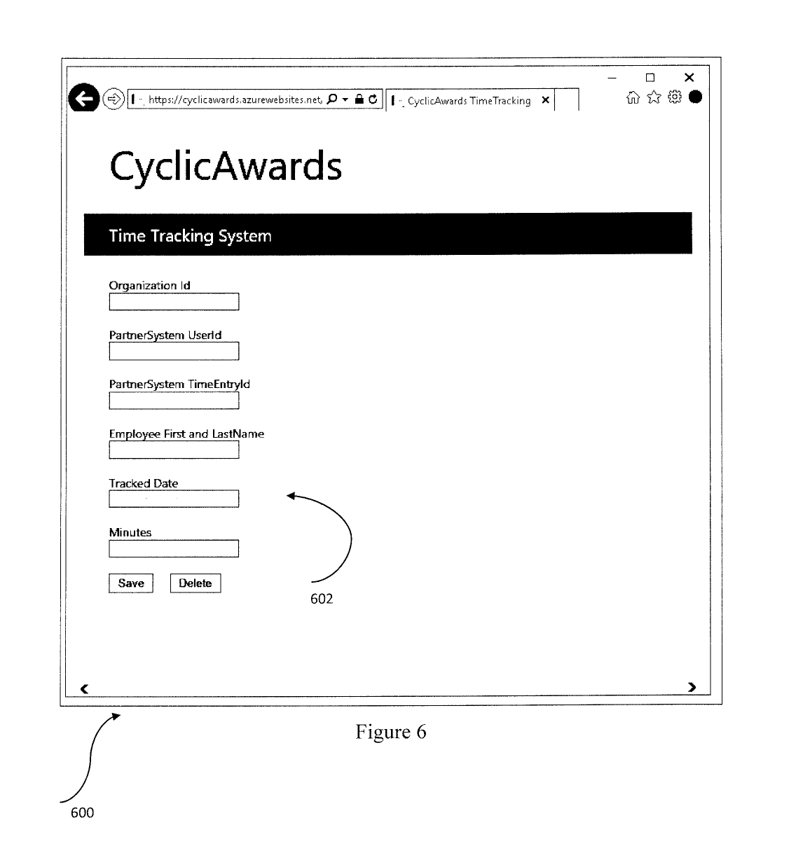

The primary program 22 is generally speaking an employee or facility production tracking program for an organization (e.g., a business). In one exemplary embodiment of the invention the primary program 22 is a timekeeping program capable of tracking billable hours for professional services such as information technology professionals, doctors, accountants, attorneys and administrative staff, all of which input data in the form of billable hours chargeable to specific clients. FIG. 6 shows a screenshot 600 which is an example of a primary software program 22 input screen. As shown there are a number of input fields 602 for inputting data into the primary program. In the present exemplary embodiment the input is a billable hours input into the primary program 22. The fields include organization ID, user ID, employee name, date, time, etc. The primary program 22 in one embodiment shown in FIG. 6 is used in the temporary or contract services industry for tracking and billing time for temporary employees, which can be accomplished by the users such as clients or temporary employees entering billable time through an Internet portal to a primary program. This keeps track of and invoices clients for billable hours for temporary or contract employees. Referring back to FIG. 1, the primary program 22 has primary program outputs 15 that are reports, invoices, purchase orders, bills of lading etc.

While the primary program 22 resides on the computer server 14 it is within the scope of this invention for the primary program 22 to reside on each of the one or more workstations 18, where the computer server 14 houses the database 16 to which various files are recorded. It is also within the scope of this invention for the primary program 22 to be located on a cloud 19 accessible through the Internet. While the database 16 is shown as being within the computer server 14 it is also within the scope of this invention for the database 16 to be several databases located on the one or more workstations 18 or for the database 16 to be located on a cloud 24 accessible through the Internet.

Also provided is a secondary program 26, which is an add-on employee task docketing in cyclic award tracking program. The add-on program is a separate software program that interacts with the primary program 22 or it is an additional feature coded directly into the primary program 22. Either way the secondary program 26 is capable of interacting with the primary program 22 such that the secondary program 26 interacts with the primary program 22 and automates the tracking and awarding of a specific behavior for the plurality of users 20 using the primary program 22 for recording tasks, according to desired rules programmed into the secondary program 26. The specific behavior can be any type of desired behavior programmed into the secondary program 26. For example the specific behavior can relate to the frequency or consistency that the individual plurality of users enter data into the primary program such as, for example billable hours being entered on a daily or weekly basis, in order to ensure that all of the user's billable time gets inputted into the primary program. In another embodiment of the invention is used in a manufacturing setting and the specific behavior is related to the physical production of one of the plurality of users for a specific time period, which can be entered by the plurality of users or automated using sensors or other monitoring devices that directly input data to the primary program 22. An example would be a manufacturing line. The secondary program 26 monitors or receives notifications from the primary program 22 that a user has recorded a task, the secondary program 26 then determines if the recorded task meets the rules setup in the secondary program, and then gives an award to the one or more users for recorded tasks that comply with the rules of the secondary program 26. The rules of the secondary program 26 are setup or determined by the secondary supervisor, which is the manager or supervisor of the one or more users with knowledge of what the parameters would be best for the organization.

The secondary program 26 resides on the network 12 either on the computer server 14 or is accessed by the primary program 22 through the cloud 24 Internet connection. In the embodiment where the secondary program 26 is located on the cloud 24 the secondary program 26 has its own database 16′ that is an optional database remotely located from the computer server 14. The database 16, 16′ in both embodiments can is used to record one or more past periodic award data files 32 specific to each of the one or more users 20, as will be described below.

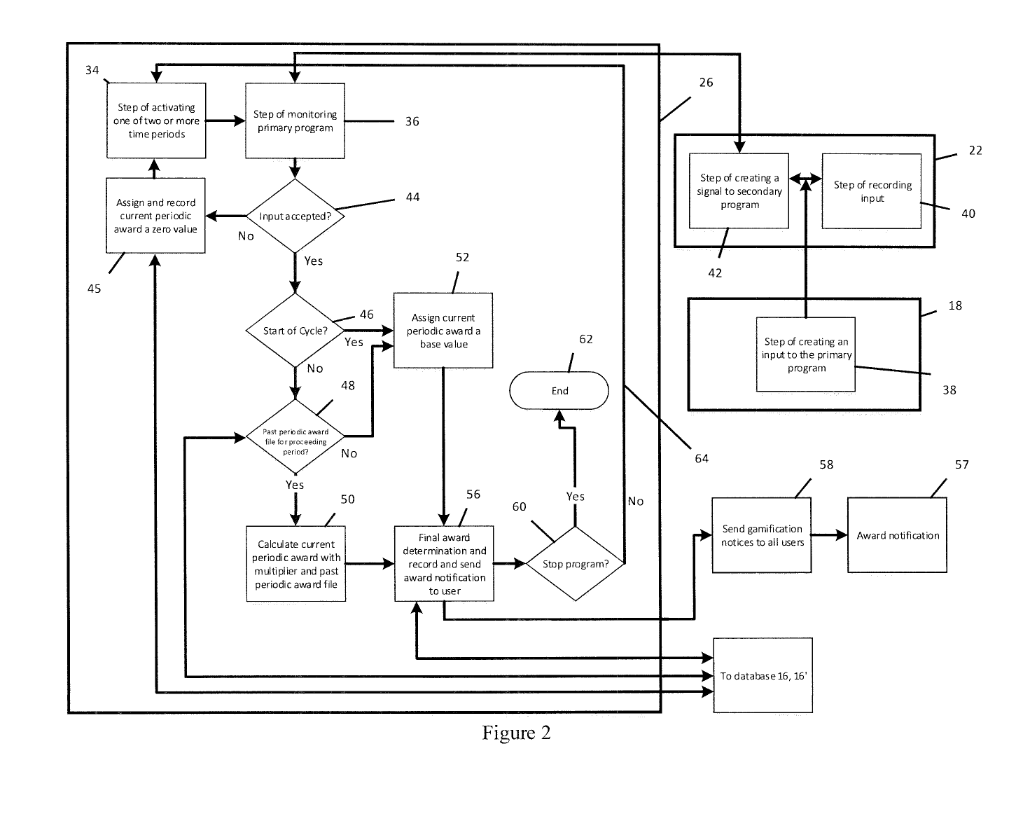

Referring to both FIGS. 1 and 2, the method 10 begins with a step 34 of activating one of two or more predetermined time periods of a first cycle of the secondary program 26. At step 36 the secondary program 26 begins monitoring the primary program 22 for the one of two or more predetermined time periods. The step 36 of monitoring includes waiting for a signal from the primary program 22 or actively sending signals from the secondary program 26 to the primary program 22 requesting information on whether there has been any activity.

Next at a step 38 the method includes using one of the one or more workstations 18 by one of the plurality of users 20 to create a user input 39 to the primary program 22. The type of input includes, but is not limited to data inputs being tracked or recorded by the primary program 22 such as a billable hours input. At a step 40 the primary program 22 records in the database 16, 16′ the input received from the one or more workstations 18. Such data inputs include billable time entries or reimbursable client expenses for embodiments where the primary program is a time keeping program, unit production numbers for production tracking programs, shipping data pertaining to the shipment of units for logistics tracking programs or any other type of program that tracks employee or facility or business outputs.

Next at a step 42 the primary program 22 creates a signal relaying the input to the secondary program 26 which is also part of the secondary program 26 step 36 of monitoring. The step 36 of monitoring also includes the secondary program 26 recording a zero value or no entry if the one of the two or more time periods lapse and no activity for the specific user was detected by the primary program 22. After step 36 the secondary program 26 proceeds to step 44 which includes using the secondary program 26 to determine whether the input is accepted by the rules programmed into the secondary program 26. Whether or not the input was for an excluded period is a determination based on many rules programmed into the secondary program 26. The rules include whether the input was for a time frame that is outside of the predetermined time period or outside of a time window, exceeds a value threshold such as being too great or too small of a value (e.g. a zero value is inputted due to inactivity) or is received during an excluded period, such as for example a Saturday or Sunday or days outside of the desired or programmed rules of the secondary program. The primary program 22 will still accept the entry however if the secondary program 26 determines that the input is excluded then at step 45 the secondary program will assign and record a current periodic award a value of zero and create a past periodic award file in the database 16, 16′. For example entry of billable hours outside of the predetermined time might be necessary for billing purposes, however it might not necessarily be a type of behavior that an award should be granted, since timely entry of billable time is more desirable; therefore the secondary program 22 is programmable so that the rules of the program do not grant an award for such entries. After step 45 the secondary program 26 will return to step 34 and begin a second one of the two or more time periods and progress to step 36 to begin monitoring the primary program 22 by the secondary program 26.

If at the step 44 the input is accepted then at a step 46 a determination is made as to whether the input is for the beginning of a cycle. For example if the cycle period is a month the secondary program 26 determine if the current timer period to which the input pertains is for the first day of the month. If the accepted input is for the beginning of a cycle then at step 52 the input is assigned a current periodic award having a value equivalent to a base value programmed into the secondary program 26. The base value is a base amount of points, dollars, etc. an individual user is awarded for their first day of compliance with the rules of the secondary program 26. Then at a step 56 the current periodic award is recorded in the database 16, 16′ as a new past periodic award file and an award notification 57 is sent from the secondary program to the user. At step 56 a determination is also made as to whether the current periodic award is a final award, which end the current cycle. When this occurs the award notification indicates that the current periodic award is a final award, which will result in a tangible award 59 being given to the user 20. The tangible award 59 is described in greater detail below.

The start of a new cycle is something that is automatically determined by the formula, however, it optionally can be an event that starts as the result of a comment inputted manually by the secondary program. However, the in the current embodiment of the invention a determination is made at step 46 regarding whether or not the input is for the beginning of the cycle. If for example the cycle is a month and the time periods are days, then the date of the input is known and the secondary program will automatically account for the start of the new cycle in the formula described below.

The award notification 57 is a message sent to the workstation 18 of the specific user 20, which informs the user that they have been awarded for their efforts. It tells the current cumulative value of their award and also provides the user with confirmation that their inputs to the primary program met the rules of the secondary program 26.

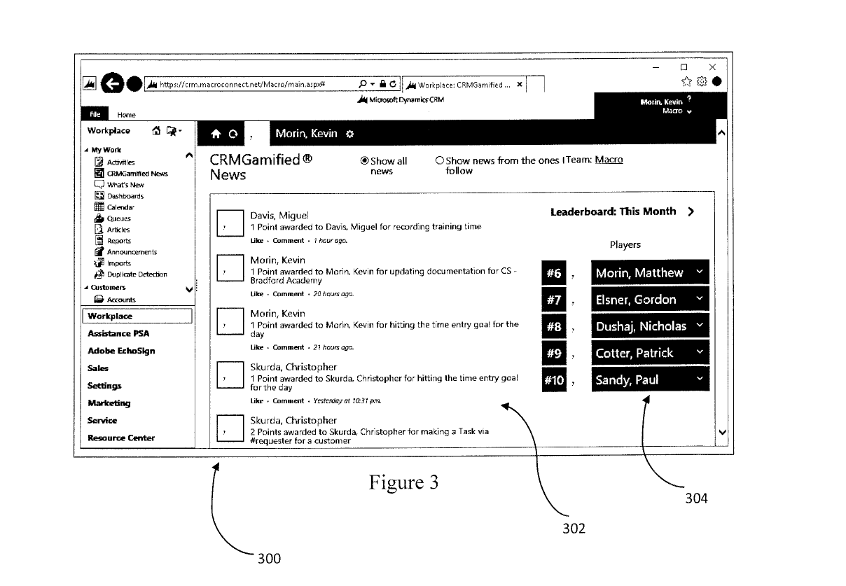

Also at the end of each time period or cycle at step 58 the secondary program 26 will send gamification notices to all of the users 20 by sending the notification to their workstation 18. FIG. 3 contains a screenshot example of a gamification screen 300. It shows a news page 302 that shows what users have received awards for the current time period. There is also a cycle leaderboard 304, which in the example is a monthly leaderboard that shows point rankings for all of the users. The notifications are instant and automatic notification requiring no confirmation or oversight from other individuals, such as management. This allows the employee to know that they completed their task and have been awarded a point, while not requiring management personnel to send or review the notification.

If at step 46 a determination is made that the current time period is not the start of a cycle then at step 48 the secondary program 26 will check the database 16, 16′ to see if there are any past periodic award files 32 for the immediately preceding time period. If there are no past periodic award file for the immediately preceding time period the secondary program will progress to the step 52 and the input is assigned a current periodic award having a value equivalent to a base value programmed into the secondary program 26. Then at a step 56 the current periodic award is recorded in the database 16, 16′ as a past periodic award file and an award notification 57 is sent from the secondary program to the user 20. The award notification 57 is a message sent to the workstation 18 of the specific user 20, which informs the user that they have been awarded for their efforts. It tells the current cumulative value of their award and also provides the user with confirmation that their inputs to the primary program met the rules of the secondary program 26. Also step 58 will be carried out where the secondary program will send the gamification notices to all of the users 20.

If at step 48 the secondary program 26 checks the database 16, 16′ and determines that there are past periodic award files 32 for the immediately preceding time period the secondary program 26 will progress to step 50 and calculates the current periodic award by taking the value of the past periodic award file and applying a multiplier programmed into the secondary program to calculate the current periodic award. Then at a step 56 the current periodic award is recorded in the database 16, 16′ as a past periodic award file and an award notification 57 is sent from the secondary program to the user 20. The award notification 57 is a message sent to the workstation 18 of the specific user 20, which informs the user that they have been awarded for their efforts. It tells the current cumulative value of their award and also provides the user with confirmation that their inputs to the primary program met the rules of the secondary program 26. Also step 58 will be carried out where the secondary program will send the gamification notices to all of the users 20. After step 56 the secondary program 26 can automatically return to step 34 to start a new time period or there is an optional step 60 where the secondary program seeks a decision on whether the program should stop, wherein a decision is presented to the person managing the secondary program 26 for the organization. If the decision is made to stop the program then it will end at step 62.

Past periodic award files 32 are specific to one of the plurality of users 20, however, it is within the scope of the invention for one or more users 20 to be a group or team or individuals competing against another group of team; therefore the past periodic award file would be for an individual group or team. Also if at step 48 the current periodic award is determined to be a final award then the program will progress to step 52 as well, but will forego carrying out the resetting step 50.

During steps 52 and 50 the calculations of the current periodic award can be made using several different types of formulas depending on how the organization using the system 10 wants to award users 20. The following is a general formula used to track and compute awards for a specific user. The formula for any given day is this:

=IF(AND(WEEKDAY($C5)>=2,WEEKDAY($C5)<=6), IF(D5=1, IF(E4>0,E4*$B$1,IF(WEEKDAY($C5)=2,E2*$B$1, IF(E4=0, 1, 0)));0),0)
$B$1=Growth rate
$C5=A date during the period
$D5=1 for compliant and 0 for non-compliant for that day
E2=Payout from two days before (used when checking on a Monday)
E4=Payout from day before

Using the above formula, awards are calculated based on inputs that are generated by the individual user 20 being compliant on a consistent regular basis over a given period of time. Completion of tasks for a given period of time, for example, consecutive days will increase the number of points that an employee gets. Calculating awards using the above formula also includes a compounded growth rate aspect. If the user 20 complies with a desired behavior over a specific time period the formula will compound the monetary award at a predetermined rate in order to encourage compliance. The formula is set up so that if the user 20 begins to comply with and receive awards, but then fails to consistently be in compliance over the entire period of time they will still receive awards, however the award will be less. Using the above formula the employee will also be able to have a new chance at the end of a given period of time because the add-on software program will reset in order to allow employees to begin to accumulate points and awards for a new time period. The portion of the above formula that handles this aspect is “E4=Payout from day before”. If the individual user 20 does not comply on a specific day the E4 value on the next day would be zero.

The above formula is used by the secondary program 26 to track an individual user's performance every day of the month. The formula resets or begins a new cycle at the end of the month and then continues on the following month where the data is compiled again over a month. The recording of data continues to occur for a specific predetermined time period, whether it be several weeks months or even years. While the above formula specifies monitoring employee tasks on a daily basis over the period of month, it is possible to make adjustments so that the secondary program 26 monitors the user's completion of tasks according to different parameters, such as weekly, monthly, quarterly or any specific period of time. For example in certain applications it might not be necessary to provide daily calculations, where a user might not be able to report tasks in the primary program 22 every day. Therefore it is possible to modify the add-on software program and the above formula to cover different time periods. It is also within the scope of this invention to modify the other variables such as growth rate.

During step 57 the one or more users 20 are notified of a final award or a current periodic award they will receive the tangible award 59 (shown in FIG. 1) that can take many forms. The tangible award can be in the form of a certificate or some type of accolade recognizing the individual user's compliance with the behavior parameters of the secondary program 26. Also the current periodic award or final award can be in the form of monetary compensation corresponding to the calculations made by the secondary program.

Additionally it is possible for the final award or the current periodic award to be in the form of points which can be saved or used by the user to cash in for an award of their choosing. For example instead of providing monetary awards the points could be used for purchasing physical goods from a catalog of offerings provided by their employer or organization. Alternatively the points could be used for other types of rewards such as vacation days, free lunches, etc. Therefore the method 10 of the present invention transforms data inputs to the primary program 22 into past periodic awards, current periodic awards and final awards having a value calculated by the secondary program 26, which ultimately manifest into a tangible award for each of the individual users 20, which is received for their compliance with a desired behavior governed by the rules of the secondary program 26.

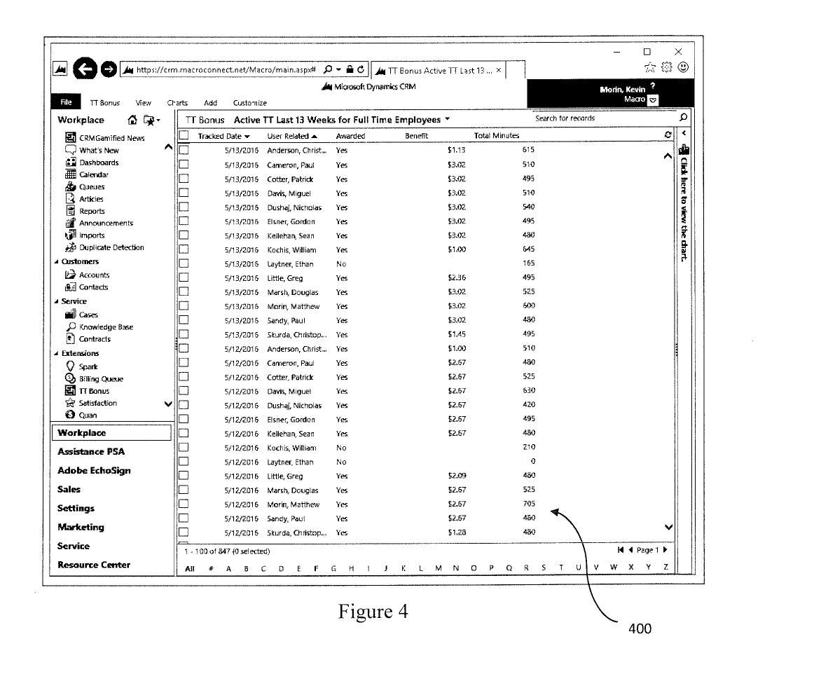

FIG. 4 is a screenshot 400 of all the users of the organization or group and their performance over the past month. The table shows the benefit awarded to each employee as well as the total minutes or points that they recorded during the time frame. This type of group performance screen or report allows management personnel to review the performance and awards given to all users of a specific group.

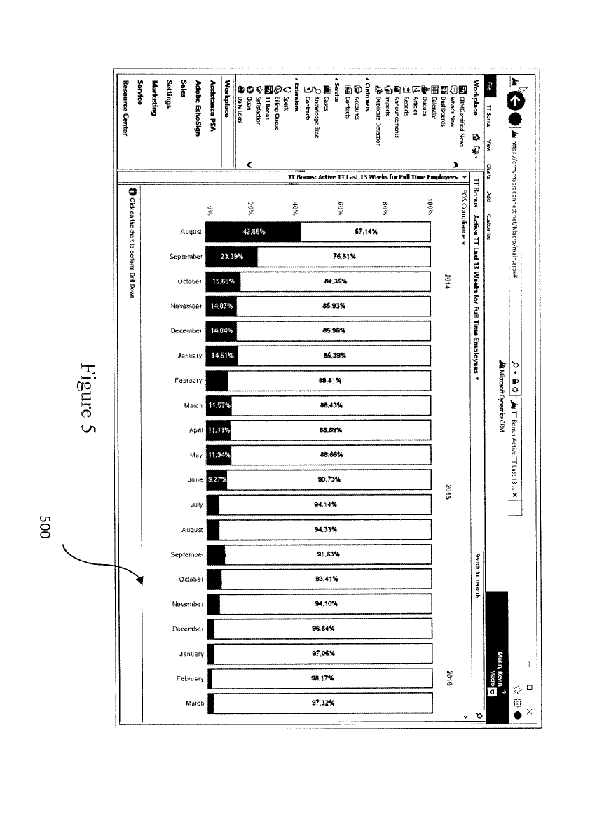

FIG. 5 of the application shows a screenshot 500 of real life results of the application of the employee cyclic award tracking system, over the course of eight months. As shown in the beginning of the implementation of the system, August 2014 the compliance level was quite low as evidenced by the low number of monetary awards being given to users. Then in the month of September 2014 compliance increased as evidenced by the fact that monetary awards given to each individual employee increased. In October 2014 compliance greatly increased as monetary awards for several of the users increased. The number of monetary awards given to each employee stayed consistently higher from the first two months as the system began motivating users to complete their tasks.

The present invention provides a system that automates the tracking and awarding specific employee behaviors over the course of a given time. The system is an add-on system that can be implemented in virtually any type of primary task management program used by users. The system provides an automatic, instantaneous gratification to the employee by letting them know when they have complied with a specific task or behavior, by awarding them points and sending them notification. The system also seeks to motivate users by creating a game like atmosphere where users can be ranked comparatively to one another to see who is a top point earner for a specific time. Additionally the present invention provides monetary awards by translating the compliance with specific tasks into points, which are then computed into a monetary award that is given to the employee for their hard work and meeting their performance or behavioral goals. Additionally the system is objective, and eliminates the subjective management, which helps to keep a sense of fairness among the users or group that are working with the system. The system also helps to eliminate the need for subjective or individual monitoring of users since the system will automatically calculate awards and send notifications to users instantaneously without relying on human input and oversight.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An employee cyclic award tracking system method comprising the steps of:
providing a network, a computer server, a database on the computer server and one or more workstations, wherein the computer server is connected to the network, said computer server being capable of receiving one or more inputs from one or more workstations connected to the network;
providing a primary program, such as a task management software program operating on the server and the one or more workstations for recording specific tasks based on the one or more inputs from the one or more workstations;
providing a secondary program that is an add-on employee cyclic award tracking program capable of interacting with the primary program, wherein the secondary program interacts with the primary program and automates the tracking and awarding a specific behavior for a plurality of users;
providing a zero value programmed on the secondary program;
activating one of two or more predetermined time periods of a first cycle of the secondary program and monitoring the primary program with the secondary program for the one of the two or more predetermined time periods;
using one of said one or more workstations by one of the plurality of users to create an input to the primary program;
relaying the input from the primary program to the secondary program;
using the secondary program to determine whether the input is accepted by rules programmed into the secondary program and creating a zero value current periodic award to one of the plurality of users when the input is not accepted and recording the zero value current periodic award as one of one or more past periodic award files in the database;
assigning or calculating a current periodic award to one of the plurality of users if an accepted input has been determined;
recording the current periodic award in the database as one of one or more past periodic award files and sending an award notification to the one of the plurality of users associated with the award notifications;
beginning a second one of the two or more time periods of the first cycle.

2. The method of claim 1 wherein the step of assigning or calculating a current periodic award includes:
providing a base value amount programmed on the secondary program;
providing a one or more multiplier calculations programmed into the secondary program;
determining whether the input is for the first one of the two or more time periods of the first cycle;
assigning the current periodic award having a value equivalent to the base value amount when the input is for the first one of two or more time periods of the first cycle;
checking the database to determine if the one of the plurality of users have any one or more past periodic award files for an immediately preceding time period;
calculating the current periodic award by using one of the one or more multiplier calculations by the one or more past periodic award files for the immediately preceding time period and assigning the current periodic award a value of the base value amount when there are no one or more past periodic award files for the immediately preceding time period.

3. The method of claim 2 further comprising the steps of:
determining that the current award is a final award of the first cycle, sending each of the plurality of users notification of the final award; and
giving a tangible award to each of the plurality of users correlating to the value of the final award based on the specific behavior over a period of time for the plurality of users.

4. The method of claim 1 further comprising the step of:
generating primary program outputs, wherein said outputs are tangible reports based on the one or more inputs received from the one or more workstations.

5. The method of claim 4 wherein the outputs are one or more selected from the group comprising invoices, purchase orders, shipping reports and production reports.

6. The method of claim 1 further comprising the steps of:
assigning a rank to each of the plurality of users using the secondary program, wherein said rank is a status position of each of the plurality of users relative to the other of the plurality of users based on a cumulative value of the one or more past periodic award files achieved by each one of the plurality of users during at least one of the two or more predetermined time periods during the first cycle;
sending a notification to all of the one or more uses at the completion of the one of the two or more time periods, wherein said notification contains data and ranks showing how each of the plurality of users rank in relation to all of the plurality of users.

7. The method of claim 1 wherein the rules inputted into the secondary program include determining if the input exceeds a threshold amount, determining if the input was received by the primary program during the predetermined time and determining if the input was for an excluded period.

8. An employee cyclic award tracking system method comprising the steps of:
providing a network, a computer server, a database on the computer server and one or more workstations, wherein the computer server is connected to the network, said computer server being capable of receiving one or more inputs from one or more workstations connected to the network;
providing a primary program, such as a task management software program operating on the server and the one or more workstations for recording specific tasks based on the one or more inputs from the one or more workstations;
providing a secondary program that is an add-on employee cyclic award tracking program capable of interacting with the primary program, wherein the secondary program interacts with the primary program and automates the tracking and awarding a specific behavior for a plurality of users;
providing a zero value programmed on the secondary program;
activating one of two or more predetermined time periods of a first cycle of the secondary program and monitoring the primary program with the secondary program for the one of the two or more predetermined time periods;
using one of said one or more workstations by one of the plurality of users to create an input to the primary program;
relaying the input from the primary program to the secondary program;
using the secondary program to determine whether the input is accepted by rules programmed into the secondary program and creating a zero value current periodic award to one of the plurality of users when the input is not accepted and recording the zero value current periodic award as one of one or more past periodic award files in the database;
providing a base value amount programmed on the secondary program;
providing a one or more multiplier calculations programmed into the secondary program;
determining whether the input is for the first one of the two or more time periods of the first cycle;
assigning the current periodic award having a value equivalent to the base value amount when the input is for the first one of two or more time periods of the first cycle;
checking the database to determine if the one of the plurality of users have any one or more past periodic award files for an immediately preceding time period;
calculating the current periodic award by using one of the one or more multiplier calculations by the one or more past periodic award files for the immediately preceding time period and assigning the current periodic award a value of the base value amount when there are no one or more past periodic award files for the immediately preceding time period; and
beginning a second one of the two or more time periods of the first cycle.

9. The method of claim 8 further comprising the step of:
recording the current periodic award in the database as one of one or more past periodic award files and sending an award notification to the one of the plurality of users associated with the award notifications.

10. The method of claim 8 further comprising the steps of:
determining that the current award is a final award of the first cycle, sending each of the plurality of users notification of the final award
giving a tangible award to each of the plurality of users correlating to the value of the final award based on the specific behavior over a period of time for the plurality of users.

11. The method of claim 8 further comprising the step of:
generating primary program outputs, wherein said outputs are tangible reports based on the one or more inputs received from the one or more workstations.

12. The method of claim 11 wherein the outputs are one or more selected from the group comprising invoices, purchase orders, shipping reports and production reports.

13. The method of claim 8 further comprising the steps of:
assigning a rank to each of the plurality of users using the secondary program, wherein said rank is a status position of each of the plurality of users relative to the other of the plurality of users based on the cumulative value of the periodic award files achieved by each one of the plurality of users during at least one of the two or more predetermined time periods during the first cycle;
sending a notification to all of the one or more uses at the completion of the one of the two or more time periods, wherein said notification contains data and ranks showing how each of the plurality of users rank in relation to all of the plurality of users.

14. The method of claim 8 wherein the rules inputted into the secondary program include determining if the input exceeds a threshold amount, determining if the input was received by the primary program during the predetermined time and determining if the input was for an excluded period.

15. An employee task docketing and cyclic award tracking system method comprising the steps of:
providing a network, a computer server, a database on the computer server and one or more workstations for storing one or more past periodic award files for plurality of users, wherein the computer server is connected to the network, said computer server being capable of receiving one or more inputs from one or more workstations connected to the network;
providing a primary program that is a time keeping and invoice processing program for tracking billable hours for service employees operating on the server and the individual workstations for recording billable hours for each of a plurality of users based on the one or more inputs from the one or more workstations;
providing a secondary program that is an add-on employee task docketing and cyclic award tracking program capable of interacting with the primary program, wherein the secondary program interacts with the primary program and automates the tracking and awarding each of the plurality of users for entering billable hours into the primary program;
providing a zero value programmed on the secondary program;
activating one of two or more predetermined time periods of a first cycle of the secondary program and monitoring the primary program with the secondary program for the one of the two or more predetermined time periods to determine if the plurality of users enter billable hours into the primary program during the one of two or more predetermined time periods of the first cycle;
using one of said one or more workstations by one of the plurality of users to create a billable hours input to the primary program;
relaying the billable hours input from the primary program to the secondary program;
using the secondary program to determine whether the billable hours input are accepted by rules programmed into the secondary program and creating a zero value current periodic award when the billable hours input is not accepted;
assigning or calculating a current periodic award to one of the plurality of users if the billable hours input meets the rules and are accepted;
recording the current periodic award in the database as one of one or more past periodic award files and sending an award notification to the one of the plurality of users associated with the award notifications;
beginning a second one of the two or more time periods of the first cycle.

16. The method of claim 15 wherein the step of assigning or calculating a current periodic award includes:
providing a base value amount programmed on the secondary program;
providing a one or more multiplier calculations programmed into the secondary program;
determining whether the billable hours input is for the first one of the two or more time periods of the first cycle;
assigning the current periodic award a value of the base value amount when the billable hours input is for the first one of two or more time periods of the first cycle;
checking the database to determine if the one of the plurality of users have any one or more past periodic award files for an immediately preceding time period;
calculating the current periodic award by using one of the one or more multiplier calculations by the one or more past periodic award files for the immediately preceding time period and assigning the current periodic award a value of the base value amount when there are no one or more past periodic award files for the immediately preceding time period.

17. The method of claim 16 further comprising the steps of:
sending each of the plurality of users notification of the current period award; and
recording the current periodic award as a new past periodic award file in the database.

18. The method of claim 16 further comprising the steps of:
determining that the current award is a final award of the first cycle, sending each of the plurality of users notification of the final award
giving a tangible award to each of the plurality of users correlating to the value of the final award based on the specific behavior over a period of time for the plurality of users.

19. The method of claim 15 further comprising the step of:
generating primary program outputs, wherein said outputs are tangible reports based on the one or more inputs received from the one or more workstations.

20. The method of claim 19 wherein the outputs are one or more selected from the group comprising invoices, purchase orders, shipping reports and production reports.

21. The method of claim 15 further comprising the steps of:
assigning a rank to each of the plurality of users using the secondary program, wherein said rank is a status position of each of the plurality of users relative to the other of the plurality of users based on the cumulative value of the periodic award files achieved by each one of the plurality of users during at least one of the two or more predetermined time periods during the first cycle;
sending a notification to all of the one or more uses at the completion of the one of the two or more time periods, wherein said notification contains data and ranks showing how each of the plurality of users rank in relation to all of the plurality of users.

22. The method of claim 15 wherein the rules inputted into the secondary program include determining if the input exceeds a threshold amount, determining if the input was received by the primary program during the predetermined time and determining if the input was for an excluded period.
